(19) United States
(12) Patent Application Publication
(10) Pub. No.: US 2025/0093228 A1
(43) Pub. Date: Mar. 20, 2025

(54) BICYCLE HANDLEBAR AND BICYCLE WITH INTEGRATED AERO MEASURING DEVICE

(71) Applicant: PremierBike, Limited., Joliet, IL (US)

(72) Inventor: Dan Kennison, Joliet, IL (US)

(21) Appl. No.: 18/888,985

(22) Filed: Sep. 18, 2024

Related U.S. Application Data
(60) Provisional application No. 63/539,471, filed on Sep. 20, 2023.

(51) Int. Cl. G01M 9/06; B62J 45/41; B62J 45/422; B62J 50/21; G01P 5/165

(52) U.S. Cl. CPC G01M 9/065; B62J 45/41; B62J 45/422; B62J 50/225; G01P 5/165

(57) ABSTRACT

The present disclosure generally relates to a bicycle handlebar comprising a frame structure and an integrated aero measuring device configured to measure coefficient of drag area (CdA) in real-time. The integrated aero measuring device may further comprise a pitot tube that is at least partially exposed to external air. The bicycle handlebar may further comprise a notification system configured to notify a bicycle operator of a change in CdA.

### CROSS-REFERENCE TO RELATED APPLICATION

This application claims priority to, and the benefit of, U.S. Provisional Application No. 63/539,471, titled “BICYCLE HANDLEBAR AND BICYCLE WITH INTEGRATED AERO MEASURING DEVICE,” filed Sep. 20, 2023, the entirety of which is herein incorporated by reference.

### FIELD

The present disclosure relates generally to an aero measuring device that is integrated into a bicycle handlebar.

### BACKGROUND

Bicycles have evolved from being used primarily as a mode of transportation to also being used for sports. This evolution has led athletes to search for any possible edge to improve their riding capabilities. Scientific advancements have enabled quantification of various factors that relate to riding performance, such as drag on a bicycle operator (rider). There has been substantial research into methods of measuring the coefficient of drag area (“CdA”) as well as how to reduce CdA during riding. Devices for measuring CdA are commonly employed in testing facilities, such as wind tunnels, in order to help athletes optimize their ability to reduce drag. Currently available devices include standalone units that are attached to a bicycle (usually on a portion of the bike handlebar) via a clamping device. The general purpose of these devices is to gather information related to very small changes in aerodynamic drag using devices including accelerometers, gyroscopes, hygrometers, thermometers, GPS, pressure sensors, barometers, and altimeters. Cyclists use data from these devices to reduce drag such that they can increase speed at a given power output. Ideally, such information would be available “on-the-go” in real-time. Drag may be reduced by selecting or adjusting different riding positions, helmet styles, visor styles, clothing, socks, equipment, equipment orientations, and so on.

However, despite the availability of commercial devices for measuring CdA, there exists a need for measuring CdA during a live ride in a manner that does not impact performance. This is because currently-available devices are bulky and prominently attached to the front of the bike on a permanent or semi-permanent basis. Such devices themselves cause an increase in CdA, thus minimizing or even eliminating any advantage data collected from them may provide.

Thus, there exists a need for a real-time understanding of CdA without sacrificing performance.

### SUMMARY

According to an aspect of the disclosure, a bicycle handlebar comprises: a frame structure comprising at least one tube surrounding an internal space; and an integrated aero measuring device housed within the internal space and configured to measure CdA in real-time.

In some embodiments, the integrated aero measuring device comprises a pitot tube that extends at least partially outside of the at least one tube so that it is exposed to external air. In some embodiments, the integrated aero measuring device comprises a notification system configured to report a change in CdA. In some embodiments, the notification system comprises at least one of a visual display system, auditory alert system, or haptic alert system configured to report CdA in real-time.

According to an aspect of the disclosure, a bicycle comprises a bicycle handlebar described above.

According to an aspect of the disclosure, a system for measuring coefficient of drag area (CdA) from a bicycle comprises: a bicycle handlebar comprising: a frame structure comprising at least one tube surrounding an internal space; and an integrated aero measuring device system housed within the internal space and configured to measure coefficient of drag area (CdA) in real-time; and a notification system, wherein the notification system is configured to notify a bicycle operator of a change in CdA. In some embodiments, the integrated aero measuring device comprises a pitot tube that extends at least partially outside of the at least one tube so that it is exposed to external air. In some embodiments, the notification system is configured to notify the bicycle operator of CdA in real-time. In some embodiments, the notification system is configured to notify the bicycle operator of CdA after the change in CdA exceeds a reporting threshold. In some embodiments, the notification system comprises at least one of a visual display system, auditory alert system, or haptic alert system configured to report a change in CdA.

According to an aspect of the disclosure, a method of notifying a bicycle operator of a change in coefficient of drag area (CdA) comprises: equipping a bicycle with a handlebar comprising: a frame structure comprising at least one tube surrounding an internal space; and an integrated aero measuring device system housed within the internal space and configured to measure coefficient of drag area (CdA) in real-time; using the bicycle; measuring CdA with the integrated aero measuring device while the bicycle is in use; and reporting a change in CdA to the operator via a notification. In some embodiments, the integrated aero measuring device comprises a pitot tube that extends at least partially outside of the at least one tube so that it is exposed to external air while using the bicycle. In some embodiments, reporting the change in CdA occurs in real-time. In some embodiments, reporting the change in CdA occurs after the CdA exceeds a reporting threshold. In some embodiments, the reporting further comprises maintaining the notification until the CdA is below the reporting threshold. In some embodiments, the notification can consist of a visual notification, an auditory notification, or a haptic notification.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The following is a description of the examples depicted in the accompanying drawings. The figures are not necessarily to scale, and certain features and certain views of the figures may be exaggerated in scale or in schematic for clarity or conciseness.

FIG. 1 illustrates an example bicycle handlebar with integrated aero measuring device in a partially deconstructed configuration.

FIG. 2 illustrates the example bicycle handlebar of FIG. 1 in a constructed configuration.

FIGS. 3a-3d illustrate schematic representations of an example visual notification system.

The foregoing summary, as well as the following detailed description, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, specific details may be set forth to provide a thorough understanding of the embodiments of the present disclosure. However, it will be clear to one skilled in the art when disclosed examples may be practiced without some or all of these specific details. For the sake of brevity, well-known features or processes may not be described in detail. In addition, like or identical reference numerals may be used to identify common or similar elements.

One or more specific embodiments of the present disclosure will be described below. In an effort to provide a concise description of these embodiments, all features with an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered. The terms “coupled,” “coupled to,” and “coupled with” as used herein, each mean a relationship between or among two or more devices, apparatuses, elements, functions, operations, processes, components, systems, subsystems, or means, constituting any one or more of: (i) a connection, whether direct or through one or more other devices, apparatuses, files, elements, functions, operations, processes, components, systems, subsystems, or means; or (ii) a functional relationship in which the operation of any one or more devices, apparatuses, elements, functions, operations, processes, components, systems, subsystems, or means depends, in whole or in part, on the operation of any one or more others thereof.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

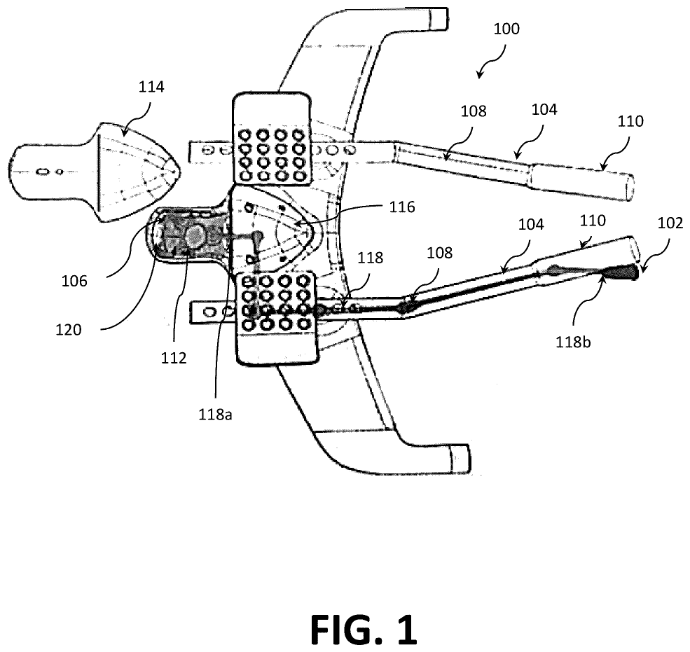

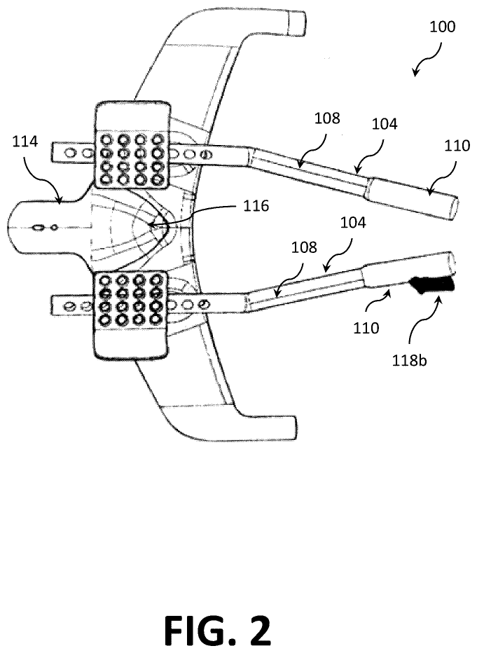

FIG. 1 illustrates an example bicycle handlebar 100 with stem cover 114 removed. FIG. 2 illustrates the example bicycle handlebar 100 with stem cover 114 secured to stem 116.

As illustrated in FIG. 1, an example bicycle handlebar 100 comprise an integrated aero measuring device 106. The example bicycle handlebar 100 comprises a frame structure 104 that includes one or more tubes 108. Each tube 108 defines or surrounds an internal space or cavity configured to house at least a portion of the integrated aero measuring device 106. In some examples, the bicycle handlebar may further comprise one or more extensions. To that end, the example bicycle handlebar 100 includes an extension 110 attached to and extending from each tube 108. Each extension 110 comprises a cavity that may be configured to house at least a portion of the integrated aero measuring device 106.

The integrated aero measuring device 106 is configured to measure the coefficient of draft area (“CdA”) in real-time while a bicycle operator is riding a bicycle. To that end, the integrated aero measuring device 106 may include a data capture or data transfer system capable of transferring data to a third party device. The integrated aero measuring device 106 may include a control box 112, wiring 118, and a pitot tube 102. As described above, at least a portion of the integrated aero measuring device may be housed within the bicycle handlebar 100. For example, the integrated aero measuring device 106 may include the control box 112 that is housed within a stem cavity 120 of a stem 116. A proximal end 118a of the wiring 118 may extend from the control box 112 through the stem 116 and into the cavity of tube 108. A distal end 118b of wiring 118 may be connected to a pitot tube 102. At least a portion of the pitot tube 102 is exposed to external air. In certain examples, the entirety of pitot tube 102 may be exposed to external air. A portion the pitot tube 102 may extend from extension 110 and at least partially outside of extension 110 such that it is exposed to external air. In other examples, the pitot tube 102 may be positioned anywhere along frame structure 104. For example, the pitot tube 102 may extend at any point along frame structure 104 at least partially outside of tube 108 such that the pitot tube 102 is exposed to external air.

According to certain examples, tube 108 and extension 110 may be cylindrically shaped. In other examples, the shape of the tube or extension may not be cylindrical, while still defining an internal space. To that end, example tubes may be defined by having a cross section of any polygonal shape or ergonomic design such as rectangular tube, triangular tube, or a hexagonal tube. In some examples, the tube may be a custom shape configured to ergonomically interface with the body shape of an individual bicycle operator.

The integrated aero measuring device 106 may further comprise a notification system configured to report CdA data to a bicycle operator. In some examples, the notification system is configured to report a change in CdA to a bicycle operator in real-time. As described above, the integrated aero measuring device 106 is configured to measure CdA during riding. In some examples, the integrated aero measuring device 106 records CdA data and displays a real-time report of said data to a bicycle operator. For example, CdA data may be reported to a bicycle operator via a digital display or a speaker.

In further examples, the integrated aero measuring device 106 may be configured to report a change in CdA to a bicycle operator. For example, the integrated aero measuring device 106 may be configured to report a notification or alert to a bicycle operator if the CdA has reached or exceeds a reporting threshold. For example, the notification or alert may be triggered when the CdA has exceeded a set deviation from a manually pre-programmed CdA value, a standard deviation away from an average CdA based on the bicycle operator's previous trips, or other relevant metrics. In some examples, the notification or alert is maintained until the CdA is below the reporting threshold. The output per watts that an athlete can achieve may be important. Athletes may be notified of their output per watts as well as a change in their output per watts. For example, on a tri-bike (bicycle for triathlons) a 6′0″ tall bicycle operator may be able to maintain an output of 250 watts and be able to get his or her CdA down to 0.230 meters squared (fast) or 0.200 meters squared (elite). Many athletes train and race with a power meter. They know they can maintain x watts for x hours or minutes based on training day after day. A system according to the present disclosure may be able to notify an athlete to when the athlete's CdA deviates from a baseline target number. Similarly, the athlete may be notified if the athlete is under the athlete's watt output target.

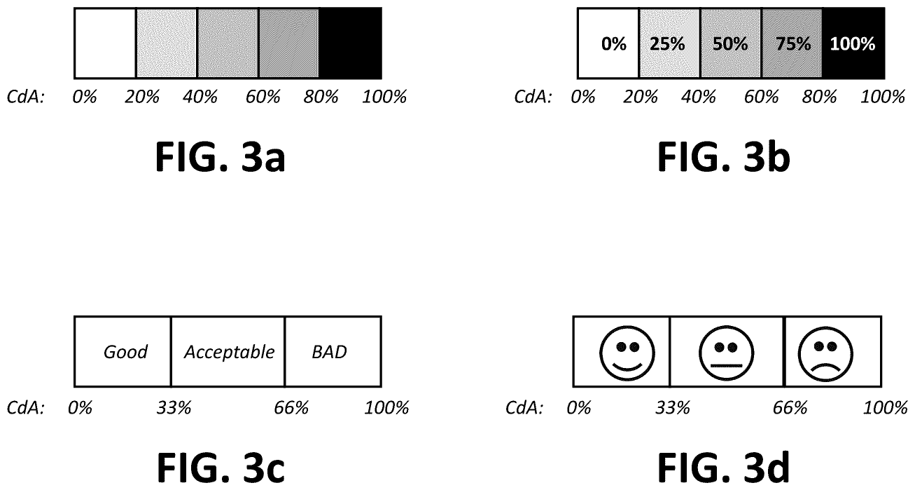

Various types of notifications or alerts may be employed by the notification system. For example, a notification may be a visual notification, an auditory notification, or a haptic notification. In further examples, a notification may include colors, words, symbols, gradients, or alarms configured to notify the bicycle operator of real-time CdA data or of a change in CdA. Example visual notifications are illustrated in FIGS. 3a through 3d. For example, as shown in FIG. 3a, a percentage change in CdA may be shown by a difference in shading. As shown in FIG. 3b, the shade may be overlaid with a percentage change. FIG. 3c illustrates an example where words may be used to indicate changes in CdA, ranging from good to acceptable to bad. FIG. 3d illustrates an example of using faces to visualize good, acceptable, and bad changes in CdA. Different colors could be used in conjunction or instead of the shading—for example, green may indicate a good CdA, yellow or amber could be used as a warning that CdA is changing into a less preferred range, and red could show a warning that CdA has veered into an unacceptable range. An auditory notification system would work in a similar way, but using sounds or spoken words to convey the same information. Similarly, a haptic notification system would provide some sort of physical indication to a bicycle rider to convey the same information. One example would be a pulsed notification in the handlebars itself that a bicycle operator would feel in his or her hands. Alternatively, the bicycle operator could be notified in a different area of his or her body where a suitable sensor is located, for example via a bicycle helmet or a wristwatch.

In some examples, the notification system may be incorporated within or attached to the structure of a bicycle handlebar or a bicycle. For example, the notification system may comprise a digital display, a speaker, or a haptic alert system incorporated within or attached to a bicycle handlebar or another portion of a bicycle. In other examples, the notification system may be a separate device that is not attached or physically integrated with a bicycle handlebar or bicycle. For example, the notification system may be a wearable device that is configured to receive data or signals from the integrated aero measuring device. To that end, as described above, some example integrated aero measuring devices include a data transfer system capable of transferring data to a third party device.

A method of reporting CdA data to a bicycle operator or notifying a bicycle operator of a change in CdA may be performed using the example bicycle handlebars, integrated aero measuring devices, and notification systems described above.

The various aspects and embodiments disclosed herein are not intended to be limiting. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

1. A bicycle handlebar comprising:
a frame structure comprising at least one tube surrounding an internal space; and
an integrated aero measuring device housed within the internal space and configured to measure coefficient of drag area (CdA) in real-time.

2. The bicycle handlebar of claim 1, wherein the integrated aero measuring device comprises a pitot tube that extends at least partially outside of the at least one tube so that it is exposed to external air.

3. The bicycle handlebar of claim 1, wherein the integrated aero measuring device comprises a notification system configured to report a change in CdA.

4. The bicycle handlebar of claim 3, wherein the notification system comprises at least one of a visual display system, auditory alert system, or haptic alert system configured to report CdA in real-time.

5. A bicycle comprising the bicycle handlebar of claim 1.

6. A system for measuring coefficient of drag area (CdA) from a bicycle, comprising:
a bicycle handlebar comprising:
a frame structure comprising at least one tube surrounding an internal space; and
an integrated aero measuring device system housed within the internal space and configured to measure coefficient of drag area (CdA) in real-time; and
a notification system, wherein the notification system is configured to notify a bicycle operator of a change in CdA.

7. The system of claim 6, wherein the integrated aero measuring device comprises a pitot tube that extends at least partially outside of the at least one tube so that it is exposed to external air.

8. The system of claim 6, wherein the notification system is configured to notify the bicycle operator of CdA in real-time.

9. The system of claim 6, wherein the notification system is configured to notify the bicycle operator of CdA after the change in CdA exceeds a reporting threshold.

10. The system of claim 6, wherein the notification system comprises at least one of a visual display system, auditory alert system, or haptic alert system configured to report a change in CdA.

11. A method of notifying a bicycle operator of a change in coefficient of drag area (CdA), the method comprising:
equipping a bicycle with a handlebar comprising:
a frame structure comprising at least one tube surrounding an internal space; and
an integrated aero measuring device system housed within the internal space and configured to measure coefficient of drag area (CdA) in real-time;
using the bicycle;
measuring CdA with the integrated aero measuring device while the bicycle is in use; and
reporting a change in CdA to the operator via a notification.

12. The method of claim 11, wherein the integrated aero measuring device comprises a pitot tube that extends at least partially outside of the at least one tube so that it is exposed to external air while using the bicycle.

13. The method of claim 11, wherein reporting the change in CdA occurs in real-time.

14. The method of claim 11, wherein reporting the change in CdA occurs after the CdA exceeds a reporting threshold.

15. The method of claim 14, wherein the reporting further comprises maintaining the notification until the CdA is below the reporting threshold.

16. The method of claim 11, wherein the notification is a visual notification, an auditory notification, or a haptic notification.
